(19) United States
(12) Patent Application Publication
(10) Pub. No.: US 2023/0348826 A1
(43) Pub. Date: Nov. 2, 2023

(54) METHODS FOR PRODUCING LOW ALCOHOL MALT BEVERAGES THAT INCLUDE HERBAL COMPOSITIONS

(71) Applicant: ALTR FLTR INC., Cave Creek, AZ (US)

(72) Inventors: Daron Hollowell, Pasadena, CA (US); Blaire Edwards, High Falls, NY (US); Will Shelton, Ware, MA (US); Richard Schatzberger, Cave Creek, AZ (US); Dustin Brunjes, Chicago, IL (US)

(21) Appl. No.: 18/141,960

(22) Filed: May 1, 2023

Related U.S. Application Data
(60) Provisional application No. 63/337,516, filed on May 2, 2022.

(51) Int. Cl. C12C 5/02; C12C 12/04; C12C 11/00; C12C 11/11

(52) U.S. Cl. CPC C12C 5/026; C12C 12/04; C12C 11/003; C12C 11/11

(57) ABSTRACT

Methods of preparing low alcohol malt beverages that include herbal compositions and that do not involve removal of alcohol to achieve an alcohol level of 2.5% or less are provided. In various implementations, methods of preparing low alcohol beverages can utilize biological approaches to limit alcohol levels in malt beverages containing herbal compositions. Herbal compositions can be selected to provide desired features to the low alcohol malt beverages.

### CROSS REFERENCE TO RELATED APPLICATIONS

This application claims benefit under 35 U.S.C. 119(e) to U.S. Provisional Patent Application Ser. No. 63/337,516, entitled “METHODS FOR PRODUCING LOW ALCOHOL MALT BEVERAGES THAT INCLUDE HERBAL COMPOSITIONS,” and filed 2 May 2022, the contents of which are incorporated herein in their entirety for all purposes.

### FIELD

The present disclosure relates to methods for making low alcohol malt beverages that include herbal compositions, and low alcohol malt beverages obtained from these methods.

### BACKGROUND

There is a growing interest around the world for low alcohol and non-alcoholic adult beverages. While low alcohol and non-alcoholic adult beverages have been around for many years, available low alcohol and non-alcoholic adult beverages have yet to provide satisfactory flavor profiles that can mimic or substitute for traditional alcoholic beverages.

For example, some methods of making low alcohol or non-alcoholic beverages include physical processes for removing alcohol from the beverage. These physical processes can be categorized as thermal and membrane-based methods. In the case of thermal processes, the alcoholic beverage is heated to evaporate the ethanol, whereby volatile aroma components can also be partly or completely evaporated. During membrane-based processes, ethanol (as well as aroma components) is removed mainly by its molecular size. Both physical methods can lead to less aromatic alcoholic beverages with reduced body and a significant acidity. In addition, these methods generally result in a low alcohol or non-alcoholic beverage that do not taste like their alcoholic counterparts. In many instances, the resulting low alcohol or non-alcoholic beverage either have very little flavor or taste so bad that they are undrinkable.

### BRIEF SUMMARY

The present disclosure is directed to processes for producing low alcohol malt beverages. In various implementations, low alcohol malt beverages include an herbal composition. In some aspects, herbal composition comprises chamomile, linden, and lemon balm. In some aspects, the herbal composition comprises reishi, dandelion, ginseng, cacao, and coffee.

In some implementations, methods of preparing low alcohol malt beverages include steps of fermenting wort with a yeast strain that does not ferment at least one of maltose or maltotriose, to thereby obtain a fermented malt beverage; and adding an herbal composition to the low alcohol malt beverage, wherein the method does not include a step of removing alcohol from the beverage, and wherein the low alcohol beverage has no more than 2.5% alcohol by volume (ABV). In some aspects, the yeast strain selectively ferments simple sugars. In some implementations, the yeast strain selectively ferments one or more of glucose, fructose, and sucrose.

In some implementations, methods of preparing a low alcohol malt beverage include steps of fermenting wort with a yeast for a period of 4 days or less to obtain a low alcohol malt beverage; arresting fermentation by reducing temperature of the fermenting wort to a temperature at which the yeast is no longer active; and adding an herbal composition comprising reishi, dandelion, ginseng, cacao, and coffee to the low alcohol malt beverage, wherein the method does not include a step of removing alcohol from the beverage, and wherein the low alcohol beverage has no more than 2.5% ABV.

In some implementations, methods of preparing a low alcohol malt beverage include steps of fermenting wort with a yeast for a period of about 3 days to about 6 days; arresting fermentation by reducing temperature of the fermenting wort to a temperature at which the yeast is no longer active; and adding an herbal composition comprising chamomile, linden flowers and leaves, and lemon balm to the low alcohol malt beverage, wherein the method does not include a step of removing alcohol from the beverage, and wherein the low alcohol beverage has no more than 2.5% ABV.

In various implementations, methods of preparing a low alcohol malt beverage include steps of providing a wort comprising malt; adding hops to the wort; adding an herbal composition to the wort; boiling the wort; and fermenting the wort with a yeast strain that does not ferment at least one of maltose or maltotriose, to thereby obtain a low alcohol malt beverage, wherein the method does not include a step of removing alcohol from the beverage, and wherein the low alcohol beverage has no more than 2.5% ABV. In some implementations, the herbal composition can be added to the wort during the step of boiling the wort. In some implementations, the herbal composition can be added to the wort prior to the step of boiling the wort. In some implementations, the herbal composition can be added to the malt beverage after fermentation. In some implementations, methods include a step of packaging the malt beverage. In some aspects, the herbal composition can be added to the malt beverage at the packaging step. In some aspects, the yeast strain selectively ferments simple sugars. In some implementations, the yeast strain selectively ferments one or more of glucose, fructose, and sucrose.

Various implementations of the methods may include providing an herbal composition that may impart one or more features to the malt beverage, including flavors, aroma, and/or functional effects. It will be understood that illustrative herbal compositions are described herein to exemplify features of methods and low alcohol compositions produced by these methods; however, various modifications to herbal compositions described can be made within the spirit and scope of this disclosure.

It should be appreciated that in some implementations, the various methods and compositions discussed herein, when applied to alcoholic beverages, can enable the production of low alcohol or non-alcoholic malt beverages that can provide desired herbal flavors. In some implementations, various methods discussed herein can provide low alcohol or non-alcoholic malt beverages that provide functional effects. As used herein, low alcohol beverages can contain 2.5% or less ABV, or 2% or less ABV, or 1% or less ABV, or 0.5% or less ABV.

### DETAILED DESCRIPTION

The present disclosure relates to processes for producing low alcohol malt beverages, and the low alcohol beverages produced thereby. In various implementations, “malt beverages” include fermented beverages in which the primary ingredient is the grain, or seed, of the barley plant which has been allowed to sprout slightly (“malt”) before it is milled, mashed, and steeped to solubilize proteins and convert starch in the malt into sugars. The term may be used interchangeably with the term “fermented malt beverage.” Optionally, other grains (malted, milled, or unmilled), and other carbohydrates can be included. In various implementations, after the mash has been steeped, the liquid wort is separated from spent grains (lautering), the wort is boiled with hops, and the boiled wort is fermented. During fermentation, yeast converts carbohydrates in the wort to ethanol and carbon dioxide, thus producing an alcoholic malt beverage. In some implementations, the alcoholic malt beverage is beer.

In various implementations, preparation of low alcohol malt beverages utilizes biological approaches to limit ethanol formation during fermentation. In some implementations, biological approaches to limit ethanol formation can involve utilization of one or more yeast strains that preferentially or selectively ferment certain sugars. In some implementations, a biological approach includes fermenting wort with a yeast strain that selectively ferments simple sugars. In some implementations, wort is fermented with a yeast strain that preferentially or selectively ferments one or more of glucose, fructose, and sucrose. In some implementations, the yeast strain does not ferment one or more of maltose and maltotriose. In some aspects, the yeast strain can be Saccharomyces chevalieri or a similar variety.

In some implementations, a biological approach to limit ethanol formation can include controlling the conditions (time and/or temperature) of fermentation. In some implementations, fermentation can be interrupted by flash cooling (sometimes referred to as “crashing” or “cold crashing”), so that fermentable sugars are not metabolized by the yeast or are only partly metabolized by the yeast. The formed alcoholic beverage has less alcohol than a beverage that would have allowed fermentation to run without interruption (for example, a beverage that would have fermented until sugars are depleted).

In various implementations, processes for producing low alcohol malt beverages do not include a step of removing alcohol from the beverage. In some aspects, processes described herein limit alcohol using biological approaches, as compared to active removal of alcohol that has been formed in the beverage. Such active removal could include physical removal of alcohol, such as heating or filtering. In some implementations, processes for producing low alcohol malt beverages provide a malt beverage having an alcohol content of 2.5% ABV, wherein the process does not include removal of alcohol.

In various implementations, processes for producing low alcohol malt beverages include a step of adding an herbal composition. Herbal compositions can impart flavors, aroma, and/or functional effects to the beverages. In some implementations, herbal compositions can include two or more herbs that are selected to impart desired features to a low alcohol malt beverage. In the context of this application, “herbs” can be understood to include not only herbaceous plants but also bark, roots, leaves, seeds, flowers, and fruit of trees, shrubs, and woody vines, and extracts of any of these that are valued for their savory, aromatic, or functional qualities. In the context of this disclosure, it is understood that the herbal compositions include herbs other than traditional hops that are included in malt beverages.

In various implementations, methods for producing low alcohol malt beverages can utilize herbal compositions to provide features to the final beverage, such as one or more of flavor, aroma, and functional effects. In the context of this disclosure, functional effects may include physiological or psychological consequences of ingesting the herbal compositions, such as stress response modulation, relaxation, energy enhancement, increased stamina, increased concentration, improved sleep quality, and the like. In some implementations, the functional effect can correspond to a symptom that includes, for example, anxiety, insomnia, stress, fatigue, and the like.

In some implementations, herbs can comprise one or more of chamomile (Matricaria recutita), lavender (Lavandula angustifolia), lemon balm (Melissa officinalis), linden, hawthorn, passionflower, ashwagandha (Withania somnifera), kava (Piper methysticum), St. John's wort (Hypericum perforatum), Valerian (Valeriana officinalis), tulsi (Holy Basil), reishi (lingzhi), catnip, milky oats/oatstraw, skullcap, California poppy, motherwort, blue vervain, Gotu Kola, wood betony, and the like. In some aspects, these types of herbs may induce relaxation and/or provide a calming effect to a person drinking the beverage. In some implementations, malt beverages that include herbal compositions described herein can provide anxiety-reducing effects at a low alcohol content, thereby avoiding undesired effects of higher alcohol content consumption.

In some implementations, herbal compositions can include a combination of individual herbs. In some implementations, an herbal composition including chamomile, linden, and lemon balm can be provided to a low alcohol malt beverage to provide a distinct flavor, aroma profile, and a calming effect. This calming effect may be a result of constituents within the herbs which provide flavor, aroma, and/or functional effects to the malt beverage. For example, over 120 constituents have been identified in chamomile flowers alone. One constituent is apigenin, which is an antioxidant that binds to specific receptors in the brain that may decrease anxiety and initiate sleep. Similarly, one active ingredient in linden is farnesol, an essential oil that helps relax the cardiovascular system. Lemon balm includes terpenes, which may play at least some role in the herb's relaxing effects. The relative amount of each of these herbs within an herbal composition can be adjusted to provide a balance of flavor, aroma, and functional effects.

In some implementations, herbs can comprise one or more of ginseng, sage (Salvia), guarana (Paullinia cupana), Bacopa monnieri, peppermint, rosemary, Rhodiola rosea, ashwagandha (Withania somnifera), gotu kola (Centella asiatica), maca (Lepidium meyenii), tulsi (Holy Basil), Schisandra, cordyceps, shilajit, eleuthero, ginko (Ginko biloba), yerba mate, coffee (Coffea arabica), cacao, green/black tea (Camellia sinensis), ginger, prickly ash (Zanthoxylum Americanum), yarrow (Achillea millefolium), and the like. In some aspects, these types of herbs may enhance energy levels. In some implementations, malt beverages that include herbal compositions described herein can provide energy enhancing effects at a low alcohol content, thereby avoiding undesired effects of higher alcohol content consumption.

In some implementations, an herbal composition including reishi, dandelion, ginseng, cacao, and coffee can be provided to a low alcohol malt beverage to provide an energy enhancing low alcohol malt beverage that has a distinctive flavor and aroma profile. Complex polysaccharide compounds within reishi mushrooms can help stimulate the immune system and fight free radical damage. These compounds may reduce the severity of chronic fatigue. Similarly, the leaves and roots of dandelion plants contain vital micronutrients as well as beta-carotene, a known antioxidant which helps lower blood pressure and increase liver function. Effects of ginseng are derived from multiple active ingredients, including ginsenosides (ginseng saponins), polysaccharides, peptides, phytosterols, polyacetylenes, polyacetylenic alcohols, and fatty acids. Cacao contains approximately 380 known chemicals and 10 psychoactive compounds. Cacao has a high content of monomeric and oligomeric flavanols, as well as methylxanthines (theobromine and caffeine). Coffee naturally contains a variety of compounds including caffeine, antioxidants, and diterpenes. These contribute not only to the unique flavor but also to the well-researched physiological effects of coffee. The relative amount of each of these herbs within an herbal composition can be adjusted to provide a balance of flavor, aroma, and functional effects.

In some implementations, herbs can comprise one or more of American Ginseng, Asian Ginseng, Ginkgo Leaf, Cordyceps Mushroom, Lion's Mane Mushroom, L-theanine, Kanna, Mimosa Bark (Albizia julibrissin), Epimedium, Damiana, Saffron, Dandelion Root, Cacao, and the like.

In some implementations, herbal compositions can be provided in a form that is easily incorporated into the malt beverage production process. In some implementations, herbal compositions can comprise an infusion. In some implementations, an herbal composition comprising an infusion can be prepared by combining fresh or dry herbs, pouring boiling water over the herbal combination, allowing the herbal combination to steep, covered, and straining off the herbs to separate the herbal infusion. In some implementations, an herbal composition comprising an infusion can be prepared by combining fresh or dry herbs, adding the herbs to boiling water, allowing the herbal combination to steep, covered, and straining off the herbs to separate the herbal infusion. In some aspects, the water is maintained at an elevated temperature during the steep, such as a temperature in a range of about 70° F. to about 200° F., or about 70° F. to about 175° F., or about 70° F. to about 150° F., or about 70° F. to about 100° F., or about 70° F. to about 90° F.

The amount of time the herbs are steeped in the water can be selected to provide optimal extraction of flavors, aromas, and/or functional components of the herbs. In some implementations, steeping time can range from 10 minutes to 8 hours.

In some implementations, an herbal composition can comprise an herbal extract. In some implementations, an herbal extract can comprise naturally occurring phytochemicals (plant produced compounds) that have been removed from the inert structural material of the plant that produced them. The extract can include a solvent such as water, alcohol, glycerin, vinegar, methanol, hexane, and the like, or combinations of two or more of these. In some aspects, the solvent is water. In some aspects, the solvent can be alcohol, in which case the extract may be called a tincture. Tinctures may be diluted with water to adjust alcohol content, and glycerin may be added to provide stability to the finished extract. In some implementations, the herbal composition can comprise an herbal oil or infused oil. In some aspects, the oil used as a base can comprise a fatty oil, for example, olive, sesame, coconut, or the like.

In some implementations, the herbal composition can comprise an essential oil. In some aspects, an essential oil can comprise the volatile components that have been separated from an aromatic herb. In some implementations, essential oils may be steam distilled or pressed directly from the fresh herb(s). Optionally, essential oils are diluted prior to use since they tend to be strong preparations.

In some implementations, herbal compositions are provided as a powder. The powder may comprise one or more herbs that have been dried and comminuted, or the power may be a powdered extract. Powdered extracts can be formed by drying liquid extracts including tinctures and water extracts, optionally under vacuum.

In some implementations, herbal compositions can be provided as fresh herbs.

In accordance with some implementations, herbal compositions can be combined with components of a low alcohol malt beverage in a manner to provide one or more features to the final beverage, such as one or more of flavor, aroma, and functional effects. In various implementations, addition of the herbal compositions can take place after the wort has been fermented. In some implementations, herbal compositions can be added prior to fermentation. In some implementations, herbal compositions can be added at packaging. Aspects of methods to prepare low alcohol malt beverages will now be discussed.

Methods for producing low alcohol malt beverages involve selecting one or more fermentable grains. In some implementations, fermentable grains include barley, wheat, oats, rye, rice, corn, pumpkin/squash, potatoes, and the like. In some implementations, a base malt is combined with complimenting grains to provide a balanced, full flavored malt beverage while imparting satisfactory color levels. Illustrative base malts include, but are not limited to, lighter malts such as Pale Ale, Maris Otter, Pilsner, Pale 2-row, Pale Ale Golden Promise, as well as malts with a greater concentration of flavor and aroma such as Vienna, Munich, and Rye. It is understood that a wide variety of base malts are commercially available and can be used in accordance with methods described herein.

In some aspects, a base malt can be combined with specialty grains such as wheat, crystal, caramel, dextrin malts, and melanoidin malt. Such specialty grains can be selected to provide desired properties to the beverage, such as overall flavor, aroma, color, mouthfeel, and foaming properties. In some implementations, a base malt can be combined with adjunct grains, such as unmalted, starchy materials such as flaked barley, flaked oats, maize, torrified wheat, pumpkin/squash, potatoes, and rice. In some aspects, adjuncts can include lactose, corn syrup, maltodextrin powder, and the like. In some implementations, adjunct grains are mashed with base malt to extract their sugars.

In some implementations, grains may be malted, such as by steeping or intermittently immersing the grain in water for a period of time (e.g., two or three days), which allows the grain to sprout. Once the grain reaches the optimum moisture level, it is germinated (e.g., for four to five days), producing green malt. The green malt is then dried to stop the germination process. In some aspects, barley is malted by germination to bring forth enzymes that break down starches and proteins to less complex water-soluble compounds (such as amino acids, fermentable sugars, and small peptides).

In some implementations, grains are combined with water and heated to temperatures around 140° F. (“mashing”), to allow malt enzyme such as amylases and proteases to degrade starch and proteins, leading to a mixture of sugars and peptides or amino acids. Spent grains are removed to provide the wort. In some aspects, the wort is composed of malt extract (the sugars for fermentation and amino acids to provide nitrogen to the yeast) and water. In some aspects, the particular composition of the wort depends on the grain bill, the mashing process, brewing water, and hops. The wort is boiled to extract bitterness, flavors, and aromas from hops, concentrate the wort through evaporation, drive off unwanted volatiles and off-flavor precursors, denature malt enzymes, and cause coagulation of proteins and phenolic substances that can later be removed.

During boil, one or more hops are added. In some implementations, hops can be added at the beginning of boil (for example, for bitterness), at the end of boil (for example, for aroma and flavor), and/or at periods of time during boil. In some implementations, one or more hops can be selected to provide a desired BU/GU ratio (Bitterness Units/Gravity Units ratio), for example in a range of about 0.10 to about 1.00, or about 0.10 to about 0.90, or about 0.10 to about 0.80, or about 0.1 to about 0.70, or about 0.1 to about 0.6, or about 0.10 to about 0.50. The particular BU/GU ratio desired may depend upon the style of malt beverage (e.g., beer).

In some aspects, a wide variety of hops can be useful to prepare low alcohol malt beverages as described herein. Generally, hops provide aroma and flavor to a malt beverage. The aromas and flavors are the result of essential oils that mimic fruits, spices, and other plants. Four main essential oils that contribute to aromas of hops include myrcene, humulene, caryophyllene, and farnesene. Myrcene (β-myrcene) oil is the most prominent and adds resinous pine, citrus, and fruity flavors to beer. Myrcene is commonly seen at levels over 50% of all available hop oils in each hop variety. Humulene (α-caryophyllene) is the second most abundant hop oil and it adds woody, hoppy, and spicy notes to beer. Caryophyllene (β-caryophyllene) oil adds black pepper, spicy, and herbal aromas to beers and is typically 5-20% of all oils in a particular hops. Farnesene (β-farnesene) oil can be absent, or present in an amount of less than 1% in most hops. When present, this oil adds fresh, green, and woody aromas to beer.

In some implementations, low alcohol malt beverages prepared as described herein can have a selected profile of myrcene, humulene, caryophyllene, and/or farnesene oils that, combined with grains, yeast, and herbal compositions, provide desired flavor and aroma profiles to the beverage.

In some aspects, bittering hops are useful in methods for producing low alcohol malt beverages. In some implementations, bittering hops are high in alpha acids, thus providing bitterness in the malt beverage. In some implementations, bittering hops have a 2:1 ratio of alpha:beta acid contents. Illustrative bittering hops include, but are not limited to, Amarillo, Golding, Saphir, and Magnum.

In some aspects, aroma hops are useful in methods for producing low alcohol malt beverages. In some aspects, hops that are considered aroma varieties are low in alpha-acids (less than 10%). These hops typically have a 1:1 ratio of alpha:beta acid contents. Illustrative aroma hops include, but are not limited to, Citra, Nelson Sauvin, Cascade, Saaz, and Simcoe.

In some implementations, methods include dual-purpose hops that have high amounts of both alpha-acids (8-15%) and essential oils. Illustrative dual-purpose hops include Citra, El Dorado, Simcoe, and Cascade. In some aspects, these hops can provide citrus-forward and fruity flavors typically desired in IPA style malt beverages.

After boiling the wort with hops, the wort is cooled, spent hops are removed, and the liquid (hopped wort) is then prepared for fermentation by cooling to the desired fermentation temperature. Yeast is pitched to the hopped wort. For typical beers, fermentation can take about one week, providing a “green beer” that is not drinkable, due to the number of bad taste and aroma compounds that are formed during fermentation. Consequently, beers can be matured (lagered) for a period of several weeks at about 32° F., during which unwanted components are slowly decomposed.

Typical sugars present in the wort and converted to ethanol and carbon dioxide by yeast during fermentation include glucose, sucrose, maltose, maltotriose, and unfermentable sugars. In some implementations, methods for producing low alcohol malt beverages utilize yeast strains that cannot, or have limited ability to, ferment maltose and/or maltotriose. In some aspects, once available simple sugars have been fermented (glucose, fructose, sucrose), this acts as a natural limitation on fermentation, and thus contributes to a low alcohol content in malt beverages. Illustrative yeast strains that exhibit a selective sugar fermentation profile include, but are not limited to, Saccharomyces ludwigii (Hefebank Weihenstephan); Torulaspora delbrueckii, Zygosaccharomyces lentus (White Labs); Hanseniaspora uvarum (Escarpment Laboratories); Saccharomyces chevalieri (Fermentis); Metshnikowia reukaufii, Pichia kluyveri (CHR Hansen); Saccharomyces cerevisae (Lallemand Brewing Lalbrew London ESB and Lalbrew Windsor); and the like. These strains can have positive contributions to flavor, such as increased esters, while keeping fermentation of fermentable sugars low. As used herein, a “selective sugar fermentation profile” means a yeast strain that selectively ferments simple sugars such as glucose, fructose and sucrose, but has limited or no ability to ferment maltose and/or maltotriose.

In some aspects, fermentation conditions can be determined based upon the yeast and wort (for example, the compounds and relative amounts in the wort). In some implementations, a yeast that only ferments certain sugars present in the wort can require a short fermentation period, for example 6 days or less, or 5 days or less, or 4 days or less, or 3 days or less. In some aspects, fermentation is continued to a point where fermentable sugars in the wort are processed. In some implementations, remaining sugars in the fermented wort will provide a sweet beverage. At the conclusion of fermentation, a fermented wort is present that includes alcohol (ethanol), carbon dioxide, glycerol, residual, unfermented sugars, and other fermentation products.

In some aspects, the fermentation temperature is selected based upon the yeast(s) utilized in the method. In some implementations, fermentation can be conducted at a temperature in a range of about 59° F. to about 77° F., or about 68° F. to about 74° F.

In some implementations, fermentation is arrested by altering the reaction conditions in manner such that the yeast is no longer active. In some implementations, this can be referred to as “arrested fermentation.” In some aspects, arrested fermentation can be used on its own or in conjunction with other methods to create low alcohol malt beverages. By halting fermentation, the brewer can control the amount of alcohol produced, resulting in a finished product with higher amounts of residual sugars and a low alcohol content. In some implementations, the process of hailing yeast activity can be done by either heating, cooling, Of using chemicals.

In some embodiments, flash cooling stops preparation of the wort by dropping the temperature to a level at which yeast are no longer active, for example, at or near freezing conditions. In some implementations, flash cooling can occur with a liquid/liquid heat exchanger with ice cold water used. Other suitable methods for flash cooling can also be used. When cooling the beer to near freezing conditions, the yeast become inactive and can be either filtered out or diminished through use of sodium metabisulphite (Campden tablets) and potassium sorbate. The cooled, fermented wort is maintained at low temperatures for a period of time to halt fermentation and allow undesirable components of the green beer to be metabolized. In some implementations, the fermented wort is maintained at a reduced temperature or 5 days or less, or 4 days or less, or 3 days or less.

In some implementations, the herbal composition is maintained at a warm temperature until it is added to the fermented wort, for example, in a range of about 68° F. to about 212° F., or about 70° F. to about 200° F., or about 70° F. to about 150° F., or about 70° F. to about 100° F., or about 70° F. to about 90° F. In some implementations, the herbal composition can be cooled to a desired temperature (e.g., 60° F. or less) and maintained at that temperature until it is added to the fermented wort.

In some implementations, the herbal composition can be added at various stages of preparation methods described herein, for example, in the boil (along with hops), at fermentation, and/or at packaging (for example, to the finished malt beverage product at bottling).

In some aspects, the fermented wort (green beer) and herbal composition can be carbonated to provide a malted beverage. In some implementations, an herbal composition can be added to the fermented wort before carbonation. In some implementations, an herbal composition can be added to the fermented wort after carbonation. In some aspects, the malted beverage is packaged (e.g., bottled) as a final step.

In various implementations, methods described herein provide low alcohol malted beverages that include herbal compositions. In some aspects, low alcohol malted beverages including herbal compositions can provide one or more desirable features. For example, low alcohol malted beverages containing herbal compositions can have an alcohol content of 2.5% v/v or less, or 2% v/v or less, or 1% v/v or less, or 0.5% v/v or less. In some aspects, low alcohol malted beverages containing herbal compositions can have desired carbonation, bitterness units, and color of typical malted beverages, with additional features provided by the selected herbal compositions, such as one or more of flavor, aroma, and functional features.

In various implementations, low alcohol malted beverages contain traces of esters as volatile compounds. These esters are produced primarily through the action o feasts during fermentation and can be influenced by yeast characteristic, wort composition, and fermentation conditions. In various aspects, these esters can have pronounced impact on the aroma and flavor profile of the beverages. The most well-described flavor-active esters in beer are ethyl acetate (solvent-buttery like aroma), ethyl caproate, ethyl caprylate (sour apple-like flavor and aroma), isoamyl acetate (fruity, banana aroma), isobutyl acetate, phenylethyl acetate, and ethyl octanoate (honey, fruity, roses, flowery aroma). Thus, in some implementations, low alcohol malted beverages may comprise one or more of ethyl acetate, ethyl caproate, ethyl caprylate, isoamyl acetate, isobutyl acetate, phenylethyl acetate, or ethyl octanoate.

In various implementations, low alcohol malted beverages contain one or more hops. In various embodiments, low alcohol malted beverages can comprise have a bitterness in a range of about 8 IBU to about 45 IBU, or in a range of about 8 IBU to about 40 IBU, or in a range of about 8 IBU to about 30 IBU, as measured by the Tinseth method.

### EXAMPLES

### Example 1. Preparation of Low-Alcohol Beer with Herbal Infusion

A low alcohol beer including an herbal composition was prepared as follows. The herbal composition was prepared by infusion and added to the beer post-fermentation. The basis for the beer was a mixture of four (4) types of malt, combined with unmilled grains (wheat and oats): golden promise malt (2.5 SRM, 44.2%), rye malt (3 SRM, 16.6%), Pilsner malt (1.7 SRM, 11.1%), Aromatic malt (33 SRM, 5.5%), flaked oats (1.4 SRM, 11.1%), torrefied wheat (2.5 SRM, 11.1%), and chocolate wheat (415 SRM, 0.5%).

An initial charge of 15 gallons warm water was added to a brewing vessel, and salts were added to adjust the pH to approximately 5.7. The mixed grains were added slowly to the warm water with mixing to minimize clumping and form a mash.

Grains were subjected to a three-step mashing regime: 20 minutes at 125° F., 40 minutes at 148° F., and 10 minutes at 168° F. The wort was collected, and concentration of dissolved solids in the wort was measured pre-boil to be 9° P. The collected wort was heated to boil and maintained at boil for a total of 75 minutes. After 15 minutes, an initial charge of 1 ounce Saphir hops (3.5%, 5 IBU) was added. When 10 minutes was left of boil, a second charge of 2 ounces Saphir hops (3.5%, 4 IBU) and 0.75 ounces Amarillo hops (9.2%, 4 IBU) was added. When 5 minutes were left in the boil, Whirlfloc was added as a clarifying agent.

The boiled wort was then cooled to 170° F., and additional hops were added in stages. After 15 minutes, 1.25 oz Amarillo hops were added (9.2%, 1 IBU). At 30 minutes, 1.25 oz Citra hops (12%, 2 IBU) were added. At 45 minutes, 1.25 oz Nelson Sauvin hops (12%, 2 IBU) were added. Total hop stand was 60 minutes.

For fermentation, a yeast strain was added that does not assimilate maltose or maltotriose but does assimilate simple sugars such as glucose, fructose, and sucrose (SafBrew™ LA-01, Saccharomyces cerevisiae var. chevalieri, commercially available from Fermentis division of S.I. Lesaffre). Yeast was hydrated in an aliquot of the wort that was taken before boiling and cooled to a temperature in a range of 77° F. to 84° F. prior to adding yeast. Yeast hydration was conducted for 15 to 30 minutes. The hydrated yeast slurry was gently stirred immediately before pitch. Yeast was pitched into the wort, and fermentation was conducted at 72° F. for 3 days to 6 days.

After fermentation, the fermented wort was cold crashed for 3 days at 32° F. Separately, an herbal composition was prepared as follows. 1.25 gallons of water was brought to boil, and a mixture of herbs was added: dried chamomile (81.6 g), dried linden flowers and leaves (41.6 g), and lemon balm (25.6 g). The herbs steeped in solution for 30 minutes, covered, followed by straining to remove particulates. The strained herbal composition (infusion) was cooled to a temperature of approximately 60° F. or less until addition to the fermented wort.

The herbal infusion was added to the cooled, fermented wort after the three-day rest period, and the beer was carbonated at 30 psi, 32° F. for 3 days.

The resulting beer may be described as a “calming pale ale,” although the herbal infusion changed the flavor and aroma profiles in significant ways so that the resulting malt beverage tasted significantly different from a traditional beer. The malted beverage had the following attributes: alcohol content of 0.5%, IBU 18 (Tinseth), color 6 SRM, carbonation 2.4 volumes of CO₂, and final gravity of 8° P. The beer provided an aroma including cascade hops, chamomile, linden, and citrus notes. The flavor provided a light hop flavor, as well as malt, green grass, grapefruit, and coriander notes.

### Example 2. Preparation of Low-Alcohol Beer with Herbal Infusion

A low alcohol beer including an herbal composition was prepared as follows. The herbal composition was prepared by infusion and added to the beer post-fermentation. The basis for the beer was a mixture of Maris Otter malt (4 SRM, 70%), flaked barley (1.7 SRM, 20%), and roasted barley (600 SRM, 10%).

An initial charge of 15 gallons warm water was added to a brewing vessel, and salts were added to adjust the pH to approximately 5.7. The mixed grains were added slowly to the warm water with mixing to minimize clumping and form a mash.

Grains were subjected to a 60-minute mash at 154° F. The wort was collected, and concentration of dissolved solids in the wort was measured pre-boil to be 9.8° P. The mash was heated to boil, at which point an initial charge of 1.5 oz Saphir hops (1.5%, 4 IBU) was added. After 30 minutes at boil, a charge of 0.5 oz Golding hops (5%, 4 IBU) was added, and boil was continued for an additional 60 minutes (total boil 90 minutes). When 5 minutes were left in the boil, Whirlfloc was added as a clarifying agent. The boiled wort was then cooled for fermentation.

For fermentation, Irish Ale Yeast (White Labs, WLP004) was hydrated in an aliquot of the wort that was taken before boiling and cooled to a temperature in a range of 77° F. to 84° F. before adding yeast. Yeast was hydrated for 15 to 30 minutes. The hydrated yeast slurry was gently stirred immediately before pitch. Yeast was pitched into the wort, and fermentation was conducted at 66° F. for 4 days.

After fermentation, the fermented wort was cold crashed for 3 days at 32° F.

Separately, an herbal composition was prepared as follows. 14 cups of water was heated on low setting in a crockpot, and a mixture of herbs was added: reishi (42 g), dandelion (35 g), ginseng (28 g), cacao (14 g), and coffee (9.8 g). The herbs steeped in solution in the crockpot for 8 hours, followed by straining to remove particulates. The strained herbal composition (infusion) was maintained at a warm temperature of approximately 80° F. until addition to the fermented wort.

The herbal infusion was added to the cooled, fermented wort after the three-day rest period, and the beer was carbonated at 30 psi, 32° F. for 3 days.

The resulting beer may be described as a “power stout,” due to the heavier herbs included in the herbal infusion. However, the herbal infusion changed the flavor and aroma profiles in significant ways. The malted beverage had the following attributes: alcohol content of 2.5%, IBU 8 (Tinseth), bitterness 0.18 BU, color 33 SRM, carbonation 2.4 volumes of CO₂, and final gravity 4.6° P. Aromas of the beer included coffee malt, mocha, milk chocolate, and malt honey. Flavors noted included coffee malt, rooty sweet earthiness, and mocha finish.

### Example 3. Preparation of Low-Alcohol Beer with Herbal Infusion

A low alcohol beer including an herbal composition was prepared as follows. The herbal composition was prepared by infusion and added to the beer post-fermentation. The basis for the beer was a mixture of Maris Otter malt (4 SRM, 69.8%), flaked barley (1.7 SRM, 20.4%), and roasted barley (600 SRM, 9.9%).

An initial charge of 15 gallons warm water was added to a brewing vessel, and salts were added to adjust the pH to approximately 5.7. The mixed grains were added slowly to the warm water with mixing to minimize clumping and form a mash.

Grains were subjected to a 60-minute mash at 154° F. The wort was collected, and concentration of dissolved solids in the wort was measured pre-boil to be 8.3° P. The mash was heated to boil, at which point an initial charge of 1.5 oz Saphir hops (1.5%, 4 IBU) was added. After 30 minutes at boil, a charge of 0.5 oz Golding hops (5%, 4 IBU) was added, and boil was continued for an additional 60 minutes (total boil 90 minutes). When 5 minutes were left in the boil, Whirlfloc was added as a clarifying agent. The boiled wort was then cooled for fermentation.

For fermentation, the yeast utilized in Example 1 was employed (SafBrew™ LA-01, Saccharomyces cerevisiae var. chevalieri, commercially available from Fermentis division of S.I. Lesaffre). Yeast was hydrated in an aliquot of the wort that was taken before boiling and cooled to a temperature in a range of 77° F. to 84° F. prior to adding yeast. Yeast hydration was conducted for 15 to 30 minutes. The hydrated yeast slurry was gently stirred immediately before pitch. Yeast was pitched into the wort, and fermentation was conducted at 72° F. for 3 days.

After fermentation, the fermented wort was cold crashed for 3 days at 32° F. Separately, an herbal composition was prepared as follows. 14 cups of water was heated on low setting in a crockpot, and a mixture of herbs was added: reishi (42 g), dandelion (35 g), ginseng (28 g), cacao (14 g), and coffee (9.8 g). The herbs steeped in solution in the crockpot for 8 hours, followed by straining to remove particulates. The strained herbal composition (infusion) was maintained at a warm temperature of approximately 80° F. until addition to the fermented wort.

The herbal infusion was added to the cooled, fermented wort after the three-day rest period, and the beer was carbonated at 30 psi, 32° F. for 3 days.

The resulting beer may be described as a “power stout,” due to the heavier herbs included in the herbal infusion. However, in contrast to the Power Stout of Example 2, the beer produced included a lower alcohol content. The malted beverage had the following attributes: alcohol content of 0.5%, IBU 8 (Tinseth), bitterness 0.22 BU, color 30 SRM, carbonation 2.4 volumes of CO₂, and final gravity 8° P. Aromas of the beer included coffee malt, mocha, milk chocolate, and malt honey. Flavors noted included coffee malt, rooty sweet earthiness, and mocha finish.

It should therefore be appreciated that the various methods and apparatuses discussed herein, when applied to alcoholic beverages, enables the production of low alcohol or substantially non-alcoholic beverages that taste like their traditional alcoholic beverage counterparts. The resulting beverage can either contain low alcohol or substantially no alcohol, while retaining many or most of the compounds that give the original alcoholic beverage its signature taste. In some implementations, the novel methods and apparatuses discussed herein can produce a low alcohol or non-alcoholic beverage that tastes the same or very similar to their alcoholic counterparts and can mimic or substitute for traditional alcoholic beverages. In some implementations, the methods and apparatuses discussed herein can be applied to other beverages or human consumable items.

The present disclosure is not to be limited in terms of the particular implementations described in this application, which are intended as illustrations of various aspects. Moreover, the various disclosed implementations can be interchangeably used with each other, unless otherwise noted. Many modifications and variations can be made without departing from its spirit and scope, as will be apparent to those skilled in the art. Functionally equivalent methods and apparatuses within the scope of the disclosure, in addition to those enumerated herein will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular implementations only and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” In addition, where features or aspects of the disclosure are described in terms of Markush groups, those skilled in the art will recognize that the disclosure is also thereby described in terms of any individual member or subgroup of members of the Markush group.

A number of implementations have been described. Various modifications may be made without departing from the spirit and scope of the invention. For example, various forms of the flows shown above may be used, with steps re-ordered, added, or removed. Accordingly, other implementations are within the scope of the following claims.

We claim:

1. A method of preparing a low alcohol malt beverage comprising steps of:
fermenting wort with a yeast strain that does not ferment at least one of maltose or maltotriose, to thereby obtain a fermented malt beverage; and
adding an herbal composition to the fermented malt beverage,
wherein the method does not include a step of removing alcohol from the beverage, and
wherein the low alcohol beverage has no more than 2.5% v/v alcohol.

2. The method of claim 1 wherein the yeast strain is capable of fermenting glucose, fructose, and sucrose.

3. The method of claim 1 wherein the herbal composition is prepared by steeping herbs in water.

4. The method of claim 1 wherein the herbal composition comprises chamomile, linden, and lemon balm.

5. The method of claim 1 wherein the herbal composition comprises reishi, dandelion, ginseng, cacao, and coffee.

6. The method of claim 1 wherein the step of adding an herbal composition to the wort comprises adding one or more herbal extracts to the wort.

7. The method of claim 1 wherein the step of adding an herbal composition to the wort comprises adding an herbal composition having a temperature of 60° F. or less.

8. The method of claim 1 further comprising carbonating the malt beverage.

9. The method of claim 8 wherein the herbal composition is added to the malt beverage prior to carbonating the malt beverage.

10. The method of claim 1 further comprising adding at least one hop variety to the wort prior to fermenting the wort.

11. The method of claim 1 wherein the yeast strain is selected from Saccharomyces chevalieri, Saccharomyces ludwigii, Torulaspora delbrueckii, Zygosaccharomyces lentus, Hanseniaspora uvarum, Metshnikowia reukaufii, Pichia kluyveri, Saccharomyces cerevisae, or a combination of any two or more of these.

12. The method of claim 1 wherein fermenting the wort is carried out in three days.

13. The method of claim 1 wherein fermenting the wort is carried out at a temperature in a range of 68° F. to 74° F.

14. A method of preparing a low alcohol malt beverage comprising steps of:
fermenting wort with a yeast for a period of 4 days or less to obtain a fermented malt beverage;
arresting fermentation by reducing temperature of the fermenting wort to a temperature at which the yeast is no longer active; and
adding an herbal composition comprising to the fermented malt beverage, the herbal composition comprising
reishi, dandelion, ginseng, cacao, and coffee or
chamomile, linden, and lemon balm,
wherein the method does not include a step of removing alcohol from the beverage, and
wherein the low alcohol beverage has no more than 2.5% v/v alcohol.

15. The method of claim 14 wherein the herbal composition is prepared by steeping herbs in water.

16. The method of claim 14 further comprising adding at least one hop variety to the wort prior to fermenting the wort.

17. The method of claim 14 wherein the low alcohol beverage has no more than 0.5% v/v alcohol.

18. A method of preparing a low alcohol malt beverage comprising steps of:
providing a wort comprising malt;
adding hops to the wort;
adding an herbal composition to the wort;
boiling the wort; and
fermenting the wort with a yeast strain that does not ferment at least one of maltose or maltotriose, to thereby obtain a fermented malt beverage,
wherein the method does not include a step of removing alcohol from the beverage, and
wherein the low alcohol beverage has no more than 2.5% v/v alcohol.

19. The method of claim 18 wherein the yeast strain is capable of fermenting glucose, fructose, and sucrose.

20. The method of claim 18 wherein the herbal composition is added to the wort at the step of boiling the wort.

21. The method of claim 18 wherein the herbal composition is added to the wort at the step of fermenting the wort.

22. The method of claim 18 further comprising packaging the low alcohol malt beverage.

23. The method of claim 22 wherein the herbal composition is added to the low alcohol malt beverage at packaging.

24. A fermented malt beverage comprising:
a yeast strain that does not ferment at least one of maltose or maltotriose;
a carbonation level in a range of 2.0 to 4.0 volumes of carbon dioxide;
ethanol in an amount in a range of 0.5% v/v to 2.5% v/v;
an herbal composition comprising (a) chamomile, linden, and lemon balm, or (b) reishi, dandelion, ginseng, cacao, and coffee,
wherein the fermented malt beverage has a bitterness in a range of 8 IBU to 45 IBU, as measured by the Tinseth method

25. The fermented malt beverage of claim 24 wherein the yeast strain is selected from Saccharomyces chevalieri, Saccharomyces ludwigii, Torulaspora delbrueckii, Zygosaccharomyces lentus, Hanseniaspora uvarum, Metshnikowia reukaufii, Pichia kluyveri, Saccharomyces cerevisae, or a combination of any two or more of these

26. The fermented malt beverage of claim 24 further comprising one or more of ethyl acetate, ethyl caproate, ethyl caprylate, isoamyl acetate, isobutyl acetate, phenylethyl acetate, or ethyl octanoate.
